(19) United States
(12) Patent Application Publication
(10) Pub. No.: US 2008/0312802 A1
(43) Pub. Date: Dec. 18, 2008

(54) Driving Force Control Device and Driving Force Control Method

(75) Inventors: Masato Kaigawa, Toyota-shi (JP); Seiji Kuwahara, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/886,176

(22) PCT Filed: Apr. 10, 2006
(86) PCT No.: PCT/IB06/00820

§ 371 Date: Sep. 12, 2007

(30) Foreign Application Priority Data
Apr. 15, 2005 (JP) 2005-118379

(51) Int. Cl. G05D 13/02; G06F 19/00

(52) U.S. Cl. 701/96

(57) ABSTRACT

In a driving force control device and driving force control method according to the invention, a first target driving force is calculated based on an operation amount of an accelerator pedal by a driver, a second target driving force, which is necessary for a vehicle to maintain a constant vehicle speed or maintain a predetermined relative distance or relative speed relationship with a target object near the vehicle, is calculated, an intention of a driver to increase or reduce the vehicle speed is determined, the first target driving force and the second target driving force are coordinated with each other, using a unit of driving force, in consideration of the intention of the driver, and driving force is controlled based on a target driving force derived through a coordination process.

### BACKGROUND OF THE INVENTION

1. Field of the Invention

The invention relates to a driving force control device that controls driving force generated in a vehicle as well as a control method for controlling the driving force. In particular, the invention relates to a driving force control device that can automatically control the driving force, for example, to maintain a predetermined vehicle speed, as well as a control method for controlling the driving force.

2. Description of the Related Art Japanese Patent Application Publication No. JP-A-2000-225868 describes a technology where a greater value is selected, as a control target value, from among a target value adopted when the vehicle is running at a constant speed and a target value calculated based on the accelerator pedal operation amount, while cruise control (hereinafter, referred to as C/C) is performed.

In the described cruise control, instructions from the C/C system to the engine control system are usually given in terms of the throttle valve opening amount (accelerator pedal operation amount) or the amount of engine torque calculated based on the throttle valve opening amount. Usually, the instructions are given in terms of the throttle valve opening amount.

In recent years, systems embedded in a vehicle have become increasingly sophisticated and diversified. Accordingly, various instructions are provided to correct the target value (conventionally, the target throttle valve opening amount) that is initially calculated based on the input of the driver (accelerator pedal operation amount). Examples of such instructions include instructions from driver support systems such as the C/C system described above, and instructions from dynamic behavior control systems such as a traction control system. It is, therefore, necessary to coordinate the target value with these instructions.

Preferably, such coordination process is performed using the unit of physical quantity suitable for the instruction, namely, the unit of driving force, instead of performing the coordination process using the unit of throttle valve opening amount (or the unit of engine torque calculated based on the throttle valve opening amount) as described in Japanese Patent Application Publication No. JP-A-2000-225868. The chief advantage to this is that the coordination process that is appropriate for the type of instruction can be performed, allowing more appropriate integrated-control of the systems. In addition, this is more advantageous because it is not necessary to change the unit of physical quantity each time the coordination process is performed, which minimizes delays in communication.

However, the configuration where the coordination process is performed using the unit of driving force, is not without problems. For example, even when the target driving force is calculated based on the accelerator pedal operation amount, it remains difficult to accurately determine the driver's intention to increase or reduce the vehicle speed based only on the target driving force and the manner in which the target driving force changes. As a result, it is difficult to perform the appropriate coordination process based on the input of the driver to increase or reduce the vehicle speed.

### SUMMARY OF THE INVENTION

The invention is made in light of the above-mentioned circumstances. It is, therefore, an object of the invention to provide a driving force control device and driving force control method that appropriately coordinates inputs by the driver to increase or decrease the vehicle speed with the various instructions, using a unit of driving force.

A first aspect of the invention relates to a driving force control device that includes first target driving force calculation means for calculating a first target driving force based on the operation amount of an accelerator pedal by a driver; second target driving force calculation means for calculating a second target driving force that is necessary for a vehicle to maintain a constant vehicle speed or maintain a predetermined relative distance or relative speed relationship with a target object near the vehicle; driver's intention determining means for determining whether a driver intends to increase or reduce the vehicle speed; coordination means for coordinating the first target driving force and the second target driving force with each other, using a unit of driving force, in consideration of the intention of the driver which is determined by the driver's intention determining means; and driving force control means for controlling driving force generation means based on a target driving force derived through the coordination process performed by the coordination means.

A second aspect of the invention relates to a driving force control method. According to the method, a first target driving force is initially calculated based on the operation amount of an accelerator pedal by a driver; and a second target driving force that is necessary for the vehicle to maintain a constant vehicle speed or maintain a predetermined relative distance or relative speed relationship with a target object near the vehicle is then calculated. It is then determined whether the driver intends to increase or reduce the vehicle speed. Based on the intention of the driver as determined, the first target driving force and the second target driving force are coordinated with each other, using a unit of driving force, in consideration of the intention of the driver; and the driving force is controlled based on the target driving force derived through the coordination process.

With the driving force control device and driving force control method described above, it is possible to perform appropriate coordination based on the intention of the driver to increase or reduce the vehicle speed using the unit of driving force.

In each of the first and second aspects, a higher priority may be given to the first target driving force than to the second target driving force, when it is determined that the driver intends to increase or reduce the vehicle speed. Also, when it is determined that the driver intends to increase the vehicle speed, a greater value is selected from among the first target driving force and the second target driving force which are positive values when applied to increase the vehicle speed. On the other hand, when it is determined that the driver intends to reduce the vehicle speed, a lesser value is selected from among the first target driving force and the second target driving force which are negative values when applied to reduce the vehicle speed.

### BRIEF DESCRIPTION OF THE DRAWINGS

The features, advantages thereof, and technical and industrial significance of the invention will be better understood by reading the following detailed description of example embodiments of the invention, when considered in connection with the accompanying drawings, in which:

FIG. 1 illustrates the top view of a vehicle provided with a vehicle integrated-control apparatus in which a driving force control device according to the invention is embedded;

FIG. 2 illustrates the system diagram of the vehicle integrated-control apparatus according to an embodiment of the invention; and

FIG. 3 illustrates the table showing the manner in which a coordination portion 70 coordinates a DSS instructed driving force Fd indicated by a signal from a DSS with an initial driving force F0 indicated by a signal from a P-DRM.

### DETAILED DESCRIPTION OF THE EXAMPLE EMBODIMENTS

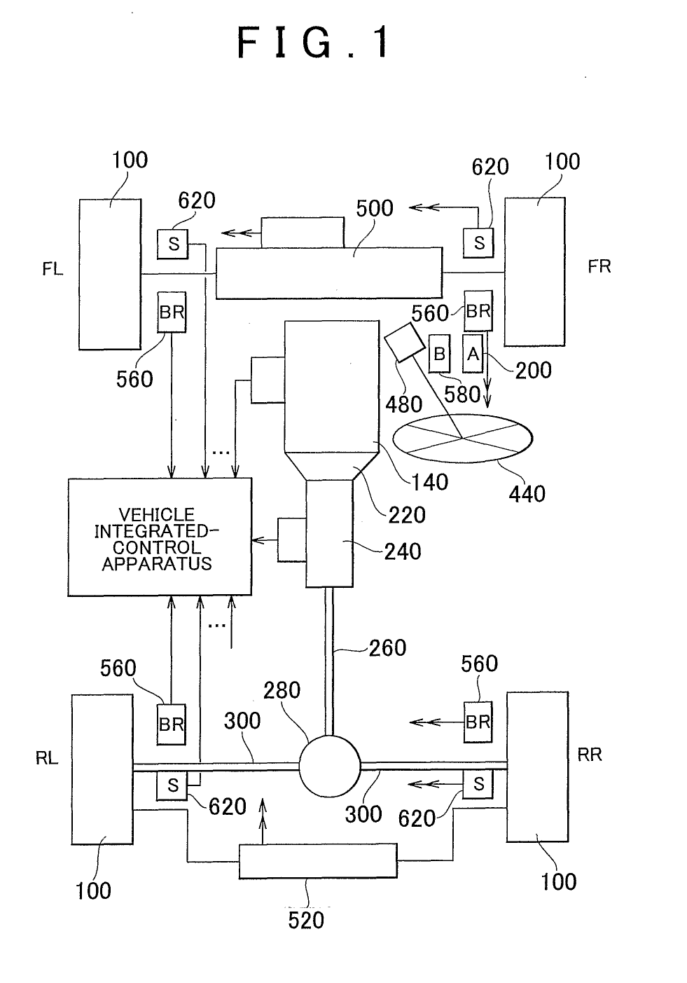

In the following description and the accompanying drawings, the present invention will be described in more detail in terms of example embodiments. First, a vehicle, that includes a vehicle integrated-control apparatus in which a driving force control device according to the invention is embedded, will be schematically described with reference to FIG. 1.

The vehicle is provided with right and left front wheels 100 and right and left rear wheels 100. In FIG. 1, “FR” denotes the right front wheel, “FL” denotes the left front wheel, “RR” denotes the right rear wheel, and “RL” denotes the left rear wheel. The vehicle includes an engine 140 as a power source. The power source is not limited to an engine. An electric motor may be used as the sole power source. Alternatively, an engine and an electric motor may be used in combination as the power source. The power source for the electric motor may be a secondary battery or a fuel cell.

The operating state of the engine 140 is electrically controlled based on the operation amount of an accelerator pedal 200 (one of the input members operated by the driver to control the forward movement, backward movement, speed, or acceleration of the vehicle) by the driver. If necessary, the operating state of the engine 140 may be automatically controlled independently of the operation of the accelerator pedal 200 by the driver.

The engine 140 is electrically controlled by electrically controlling, for example, the opening amount of a throttle valve (not shown) (hereinafter, referred to as a 10, “throttle valve opening amount”) provided in an intake manifold of the engine 140, the amount of fuel injected into a combustion chamber of the engine 140, or the angular position of an intake camshaft that adjusts the valve opening/closing timing.

The example vehicle is a rear-wheel drive vehicle where the right and left front wheels are the driven wheels and the right and left rear wheels are the drive wheels. Accordingly, the output shaft of the engine 140 is connected to the right and left rear wheels via a torque converter 220, a transmission 240, a propeller shaft 260, a differential gear unit 280, and a drive shaft 300 that rotates along with the rear wheels. The torque converter 220, the transmission 240, the propeller shaft 260, and the differential gear unit 280 are power transmission elements shared by the right and left rear wheels. However, the application of vehicle integrated-control apparatus according to the embodiment is not limited to rear-wheel drive vehicles. The vehicle integrated-control apparatus may be applied, for example, to front-wheel drive vehicles where the right and left front wheels are the drive wheels and the right and left rear wheels are the driven wheels. Also, the vehicle integrated-control apparatus may be applied to four-wheel drive vehicles where all the wheels are the drive wheels.

The transmission 240 is an automatic transmission. The automatic transmission electrically controls the speed ratio, based on which the speed of the engine 140 is converted into the rotational speed of the output shaft of the transmission 240. This automatic transmission may be either a stepped transmission or a continuously variable transmission (CVT).

The vehicle includes a steering wheel 440 operated by the driver. A steering reaction force supply device 480 electrically supplies the steering wheel 440 with a steering reaction force, that is, a reaction force corresponding to the operation of the steering wheel 440 performed by the driver (hereinafter, sometimes referred to as “steering”). The steering reaction force can be electrically controlled. The orientation of the right and left front wheels, namely, the steering angle of the front wheels is electrically controlled by a front steering device 500. The front steering device 500 controls the steering angle of the front wheels based on the angle by which the driver has turned the steering wheel 440. If necessary, the front steering device 500 may automatically control the steering angle of the front wheels independently of the operation of the steering wheel 440 by the driver. In other words, the steering wheel 440 may be mechanically isolated from the right and left front wheels. Similarly, the orientation of the right and left rear wheels, namely, the steering angle of the rear wheels is electrically controlled by a rear steering device 520. The wheels 100 are provided with respective brakes 560 that are applied to suppress rotation of the wheels 100. The brakes 560 are electrically controlled based on the operation amount of a brake pedal 580 (one of the input members operated by the driver to control the forward movement, backward movement, speed, or acceleration of the vehicle) by the driver. If necessary, the wheels 100 may be individually and automatically controlled.

In the example vehicle, the wheels 100 are connected to the vehicle body (not shown) via respective suspensions 620. The suspension properties of each suspension 620 can be electrically controlled independently of the other suspensions 620.

The following actuators are used to electrically control the corresponding components described above:

(1) an actuator that electrically controls the engine 140;

(2) an actuator that electrically controls the transmission 240;

(3) an actuator that electrically controls the steering reaction force supply device 480;

(4) an actuator that electrically controls the front steering device 500;

(5) an actuator that electrically controls the rear steering device 520;

(6) actuators that electrically control the brakes 560; and

(7) actuators that electrically control the suspensions 620.

Only commonly used actuators are listed above. Whether all the actuators listed above are required depends on the specifications of the vehicles. Some vehicles do not include one or more actuators listed above. Alternatively, other vehicles may include other actuators, in addition to the actuators listed above, such as an actuator used to electrically control the ratio between the steering amount of the steering wheel 440 and the steered amount of the steered wheel (steering ratio), and an actuator used to electrically control a reaction force of the accelerator pedal 200. Accordingly, the invention is not limited to the particular actuator configurations mentioned above.

As shown in FIG. 1, the vehicle integrated-control apparatus that is mounted in the vehicle is electrically connected to the various actuators described above. A battery (not shown) serves as the electric power source for the vehicle integrated-control apparatus.

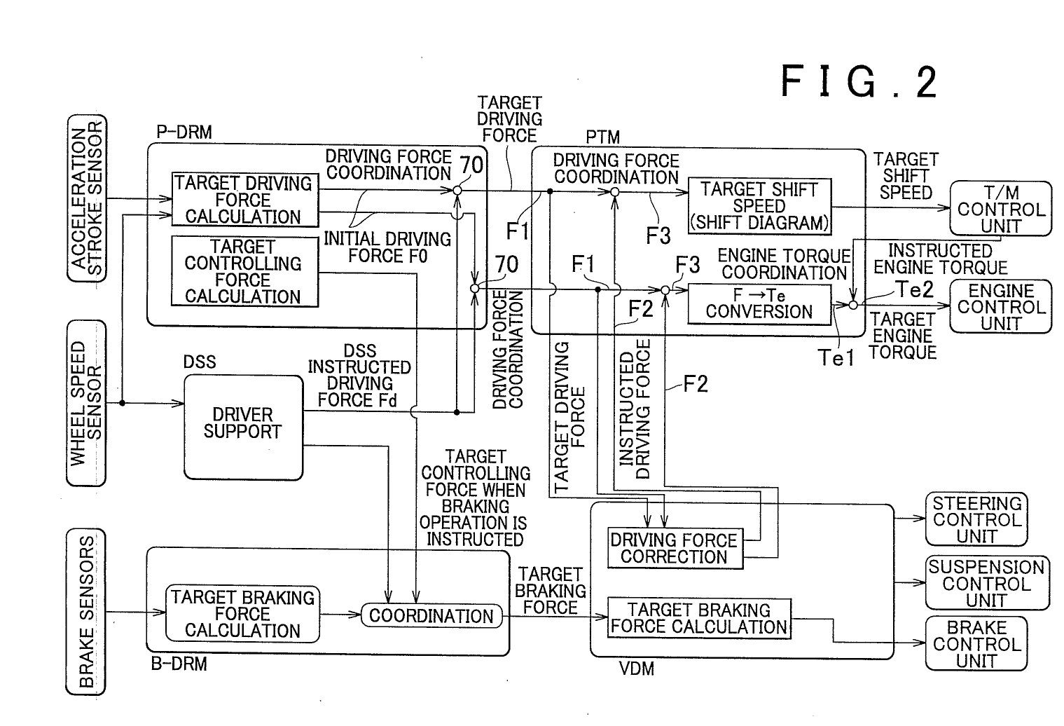

FIG. 2 illustrates the system diagram of the vehicle integrated-control apparatus according to the embodiment of the invention.

As in the case of a commonly used ECU (electronic control unit), each manager (and model) described below may be a microcomputer that includes, for example, ROM that stores control programs, RAM where results of calculations and the like are stored and the data can be retrieved and/or updated, a timer, a counter, an input interface, an output interface, and the like. In the following description, the control units are grouped by function, and referred, for example, to as a P-DRM, a VDM, and the like. However, the P-DRM, the VDM, and the like need not be configurations physically independent of each other. The P-DRM, the VDM, and the like may be configured integrally with each other using an appropriate software structure.

As shown in FIG. 2, at the highest level of the drive control system, a manager that functions as a driver's intention determining portion of the drive control system (hereinafter, referred to as a “P-DRM”: Power-Train Driver Model) is arranged.

At the highest level of the drive control system, a driver support system (hereinafter, referred to as a “DSS”: Driver Support System) is arranged in parallel to the P-DRM.

At the level superior to the P-DRM, an acceleration stroke sensor is arranged. The acceleration stroke sensor produces an electric signal corresponding to the operation amount of the accelerator pedal 200, which directly reflects the input of the driver.

At the level superior to the DSS, wheel speed sensors are arranged. The wheel speed sensors are provided for the respective wheels 100. Each wheel speed sensor 100 outputs a pulse signal each time the wheel 100 rotates through a predetermined angle.

The P-DRM receives the signals output from the acceleration stroke sensor and the wheel speed sensors. At the highest level in the P-DRM, a target driving force calculation portion calculates an initial driving force F0 (N) based on the accelerator pedal operation amount (%) and the wheel speed No (rpm) indicated by the electric signals from the acceleration stroke sensor and the wheel speed sensors, respectively. In this specification, a driving force that is applied to increase the vehicle speed is referred to as a “positive driving force”, and a driving force that is applied to reduce the vehicle speed is referred to as a “negative driving force”. Where appropriate, the negative driving force may be referred to as a “braking force”.

The initial driving force F0 may be derived in the following manner: 1) the target acceleration G (m/s2) is calculated based on an appropriate three-dimensional map using the accelerator pedal operation amount (%) and the wheel speed (rpm) as parameters, 2) the target driving force is derived by converting the target acceleration G (m/s2) into the physical quantity suitable for force (N), and 3) the initial driving force F0 is derived by correcting the target driving force using an uphill-slope compensation amount (N) that is determined based on running resistance (N) and a road inclination.

The signal indicating the initial driving force F0 (N) thus determined is transmitted to the control elements at the subordinate levels via two signal lines extending from the target driving force calculation portion. Hereafter, the two routes through which the signal indicating the initial driving force F0 is transmitted will be referred to as an “engine control system transmission route” and a “T/M control system transmission route”. The initial driving force F0 indicated by the signal transmitted through the engine control system transmission route may be smoothed to prevent an abrupt change in driving force. However, the initial driving force F0 indicated by the signal transmitted through the T/M control system transmission route is generally not smoothed.

As shown in FIG. 2, if an instruction to correct the initial driving force F0 (N) is provided from the DSS, a coordination portion 70, described later in detail, coordinates the initial driving force F0 (N) with a DSS instructed driving force Fd (N) specified in the DSS instruction, in each route.

The DSS provides an appropriate instruction as an alternative to the input of the driver or an appropriate instruction to make a correction to the input of the driver, based on the information concerning obstacles located around the vehicle, which is captured, for example, by a camera or a radar, the road information and ambient area information obtained from a navigation system, the current position information obtained from a GPS positioning device of the navigation system, or various information obtained via communication with the operation center, vehicle-to-vehicle communication or road-to-vehicle communication.

For example, when the user turns the cruise control on, generally by manipulating a cruise switch provided near the steering wheel, the DSS calculates and provides an instruction indicating the DSS instructed driving force Fd (N) that is necessary to maintain a desired vehicle-to-vehicle distance (or a vehicle-to-vehicle time interval) with the preceding vehicle.

For example, in constant vehicle speed running control, the DSS calculates and provides the instruction indicating the DSS instructed driving force Fd (N) that is necessary to maintain a predetermined constant vehicle speed, based on the information concerning the vehicle speed indicated by the signal transmitted, for example, from the wheel speed sensors.

For example, in deceleration control for bringing the vehicle to stop at a stopping position, the DSS detects a stopping position ahead of the vehicle based on the information concerning obstacles located around the vehicle, the road information, the ambient area information, etc. The DSS then calculates and provides an instruction indicating the DSS instructed driving force Fd (<0) that is necessary to bring the vehicle to stop at the stopping position, if it is determined, based on the positional relationship between the stopping position and the vehicle and the manner in which the vehicle speed is reduced, that intervention-deceleration control needs to be performed.

For example, in the deceleration control that is performed to reduce the vehicle speed to an appropriate vehicle speed (vehicle speed suitable for the curvature radius of a curve, etc.) before the vehicle passes the starting point of a sharp curve, the DSS detects a stopping position ahead of the vehicle based on the information concerning obstacles around the vehicle, the road information, the ambient area information, etc. Then, the DSS calculates and provides an instruction indicating the DSS instructed driving force Fd (<0) that is necessary to reduce the vehicle speed such that it becomes an appropriate vehicle speed at the starting point of the curve before the vehicle passes the starting point, if it is determined, based on the positional relationship between the stopping position and the vehicle and manner in which the vehicle speed is reduced before the vehicle passes the starting point of the curve, that the intervention deceleration control needs to be performed.

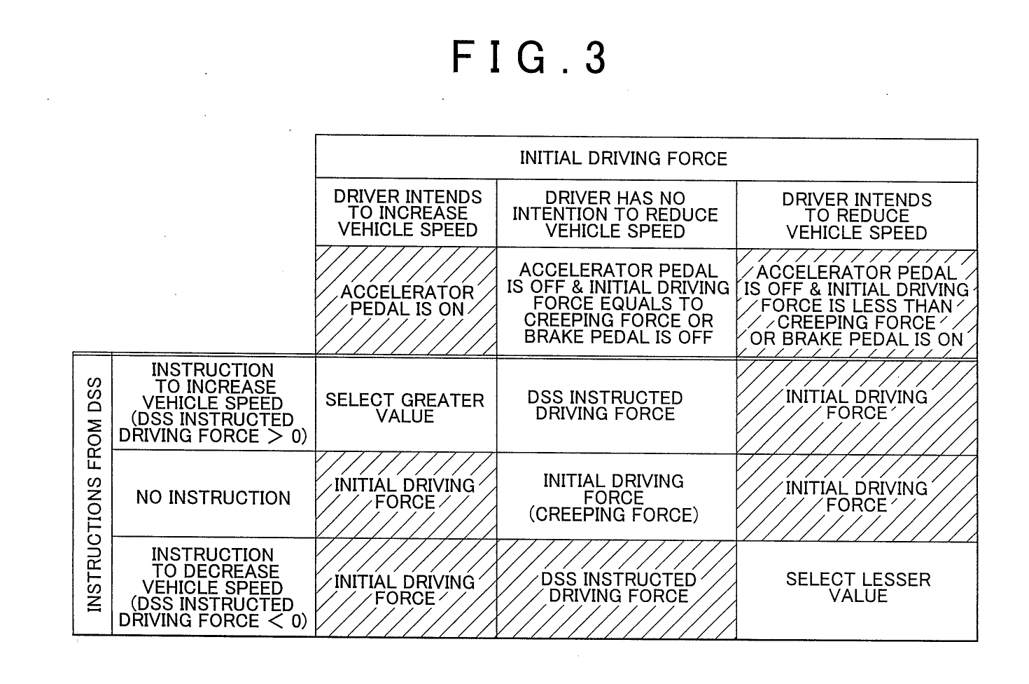

FIG. 3 illustrates the table showing the manner in which the coordination portion 70 coordinates the DSS instructed driving force Fd indicated by the signal from the DSS with the initial driving force F0 indicated by the signal from the P-DRM. FIG. 3 illustrates the typical example of the manner appropriate especially for the cruise control. For other controls, appropriate modification may be made to the manner shown in the table in FIG. 3 depending on the purpose and properties of the control.

According to the embodiment, as shown in FIG. 3, the DSS instructed driving force Fd may be classified into three types, that are, the DSS instructed driving force that is a positive value, DSS instructed driving force that is zero (there is no instruction), and the DSS instructed driving force that is a negative value. Also, the intention of the driver to increase/reduce the vehicle speed is classified into three types, that are, the intention to increase the vehicle speed, no intention to reduce the vehicle speed, and the intention to reduce the vehicle speed. FIG. 3 shows results of coordination corresponding to the combinations of the three patterns of the DSS instructed driving force and the three patterns of the intention of the driver to increase/reduce the vehicle speed by using a three-by three-matrix table.

As shown in FIG. 3, when the driver intends to increase the vehicle speed, the accelerator pedal 200 is operated by the driver (the accelerator pedal 200 is ON). When the driver has no intention to reduce the vehicle speed, the accelerator pedal 200 is not operated, and the initial driving force F0 corresponds to creeping force or the brake pedal 580 is not operated. When the driver intends to reduce the vehicle speed, the accelerator pedal 200 is not operated, and the initial driving force F0 is less than the creeping force or the brake pedal 580 is operated (the brake pedal 580 is ON). A determination portion (not shown) determines whether the driver has an intention to increase the vehicle speed, has no intention to reduce the vehicle speed, or has an intention to reduce the vehicle speed based on the signals output from the acceleration stroke sensor and the brake sensor (the master cylinder pressure sensor, the brake depressing force sensor, etc.) and the initial driving force F0 indicated by the signal from the P-DRM. Then, a flag corresponding to the intention of the driver is set.

When the flag thus set indicates that the driver intends to increase the vehicle speed, if the DSS instructed driving force Fd is a positive value, the coordination portion 70 selects the greater value from among the DSS instructed driving force Fd and the initial driving force F0. On the other hand, if the DSS instructed driving force is zero or a negative value, the coordination portion 70 selects the initial driving force F0. Similarly, when the flag indicates that the driver intends to reduce the vehicle speed, if the DSS instructed driving force Fd is a positive value or zero, the coordination portion 70 selects the initial driving force F0. On the other hand, if the DSS instructed driving force Fd is a negative value, the coordination portion 70 selects the lesser value from among the DSS instructed driving force Fd and the initial driving force F0 (the value at which a greater braking force is instructed). Although not described in detail here, the case where the driver has no intention to reduce the vehicle speed is as shown in FIG. 3.

Hereinafter, the target driving force (the initial driving force F0 or the DSS instructed driving force Fd) that is calculated through the coordination process performed by the coordination portion 70 will be referred to as a “target driving force F1”. As shown in FIG. 2, the signal indicating the target driving force F1 (N) is transmitted to a power-train manager (hereinafter, referred to as a “PTM”: Power-Train Manager). The PTM is a manager that functions as an instruction coordination portion of the drive control system.

At the highest level of the PTM, the signal indicating the target driving force F1 (N) from the P-DRM is transmitted to a manager of the dynamic behavior control system (hereinafter, referred to as a “VDM”: Vehicle Dynamics Manager). The VDM is arranged at the level subordinate to a manager that functions as a driver's intention determining portion of the brake control system (hereinafter, referred to as a “B-DRM”: Brake Driver Model). The VDM is a manager that functions as a vehicle movement coordination portion. Examples of such system that stabilizes the dynamic behavior of the vehicle include a traction control system (a system that suppresses unnecessary wheelspin of the drive wheels that is likely to occur when the vehicle starts or accelerates on a slippery road), a system that suppresses a side skid that is likely to occur when the vehicle enters a slippery road, a system that stabilizes the orientation of the vehicle to prevent the vehicle from spinning out or sliding off the track if the limit of stability is reached when the vehicle is going round the curve, and a system that actively makes a difference in the driving force between the right and left rear wheels of the four-wheel drive vehicle, thereby causing a yaw moment.

At the level subordinate to the VDM, a steering control unit that controls the actuators for the front steering device 500 and the rear steering device 520, and a suspension control unit that controls the actuators for the suspensions 620 are arranged in parallel with the brake control unit that controls the actuators for the brakes 560. In the B-DRM, a target braking force calculation portion converts the electric signal transmitted from a brake sensor into a signal indicating a target braking force. This signal is then transmitted via the VDM to the brake control unit. While not described in detail in this specification, the target braking force calculated by the target braking force calculation portion undergoes various correction (coordination) processes in the same or similar manner in which the target driving force F1 undergoes correction (coordination) processes, as described later in detail. Then, the signal indicating the target braking force derived after correction (coordination) is output to the brake control unit.

The target driving force F1 is primarily determined based mainly on the input of the driver. A driving force correction portion of the VDM secondarily provides an instruction to correct the target driving force F1 to stabilize the dynamic behavior of the vehicle. Namely, the driving force correction portion of the VDM provides instructions to correct the target driving force F1, if necessary. In this case, preferably, the driving force correction portion of the VDM indicates the absolute amount of the target driving force F1 that should replace the target driving force F1, not the correction amounts AF by which the target driving force F1 should be increased or decreased. Hereafter, the absolute amount of the target driving force indicated by the instruction from the VDM, which is derived from the target driving force F1, will be referred to as a “target driving force F2”.

As shown in FIG. 2, a signal indicating the target driving force F2 is input in the PTM. As shown in FIG. 2, the signal indicating the target driving force F2 is input in each of the engine control system transmission route and the T/M control system transmission route. At the input portion of each route, the target driving force F2 is coordinated with the target driving force F1. In this coordination process, preferably, a higher priority is given to the target driving force F2 than to the target driving force F1, because a higher priority should be given to a stable dynamic behavior of the vehicle. Alternatively, the final target driving force may be derived by appropriately assigning weights to the target driving force F2 and the target driving force F1. To give a higher priority to the stable dynamic behavior of the vehicle, the greater weight is assigned to the target driving force F2 than to the target driving force F1. The target driving force derived through such coordination process will be referred to as a “target driving force F3”.

In the T/M control system transmission route, the target driving force F3 is converted into the throttle valve opening amount Pa (%), and the signal indicating the throttle valve opening amount Pa (%) is transmitted to a target shift speed setting portion, as shown in FIG. 2. The target shift speed setting portion sets the final target shift speed based on the predetermined shift diagram (shift diagram indicating the relationship between the throttle valve opening amount and the wheel speed No). The final target shift speed may be directly set based on the predetermined shift diagram (shift diagram indicating the relationship between the driving force and the wheel speed No) without converting the target driving force F3 into the throttle valve opening amount Pa (%).

The signal indicating the target shift speed thus set in the PTM is output to the T/M control unit arranged at the level subordinate to the PTM. The T/M control unit controls the actuator for the transmission 240 to achieve the target shift speed.

In the engine control system transmission route, an “F→Te conversion portion” converts the mode of expressing the target driving force F3 from the mode where it is expressed by the driving force (N) to the mode where it is expressed by the engine torque (Nm), as shown in FIG. 2. An engine torque coordination portion coordinates a thus derived target engine torque Te1 (Nm) with the instructed engine torque (Nm) indicated by the signal transmitted from the T/M control unit to the PTM. The target engine torque derived through such coordination will be referred to as a “target engine torque Te2”.

The signal indicating the target engine torque Te2 is output to the engine control unit arranged at the level subordinate to the PTM. The engine control unit and the T/M control unit control the actuator for the engine 140 to achieve the target engine torque indicated by the signal from the PTM.

According to the embodiment described so far, the target driving force F1 calculated by the target driving force calculation portion of the P-DRM undergoes various correction (coordination) processes, and the signal indicating the target driving force that has undergone various correction (coordination) processes is output to the engine control unit and the T/M control unit. These control units control the actuators for the engine 140 and the transmission 240, whereby the target driving force F1 (if the target driving force F1 has undergone the coordination process, the target driving force F2 or the target driving force F3) is achieved.

In the embodiment, each coordination portion performs the coordination process using the unit of physical quantity suitable for the instruction. Because the DSS and the VDM are basically the systems that control driving force, preferably, instructions from the DSS and the VDM are provided and the coordination process are performed using the unit of driving force. Because the T/M control unit is basically a unit that controls driving torque, preferably, instructions from the T/M control unit are provided and the coordination process is performed using the unit of engine torque. According to the embodiment described above, because instructions are provided and the coordination processes are performed using the appropriate units of physical quantities, appropriate coordination processes suitable for the instructions can be performed. In addition, the unit of physical quantity need not be changed between when the coordination process is performed and when an instruction is provided. Also, modification of the communication software structure due to the change in the unit of physical quantity can be avoided. As a result, inefficiency caused by such change and modification can be effectively minimized.

However, when the coordination process is performed using the unit of driving force, even if the initial driving force F0 is calculated based on the operation amount of the accelerator pedal, the intention of the driver to increase/reduce the vehicle speed cannot be accurately determined based only on the initial driving force F0 and the manner in which it changes. As a result, it is difficult to perform the appropriate coordination process based on the intention of the driver. The driving force may be a negative value, unlike the accelerator pedal operation amount (throttle valve opening amount). Accordingly, with the coordination process where the greater value is selected from among the two values of the driving force that should be coordinated with each other, a problem will occur if a negative driving force needs to undergo coordination.

In contrast, according to the embodiment described with reference to FIG. 3, the intention of the driver to increase/reduce the vehicle speed is determined and the coordination process is performed in consideration of the intention of the driver, instead of performing the coordination process where the greater or lesser value is selected from among the driving force F1 and the driving force Fd that should be coordinated with each other. Thus, even with the configuration where the coordination process is performed using the unit of driving force, an appropriate coordination process based on the intention of the driver can be performed. In addition, according to the embodiment, the manner in which the coordination process is performed is changed depending on whether the driving force F1 and the driving force Fd are negative values or positive values. Accordingly, the driving force F1 and the driving force Fd can be appropriately coordinated with each other even when the driving force F1 and the driving force Fd are negative values.

The embodiment of the invention that has been described in the specification is to be considered in all respects as illustrative and not restrictive. The technical scope of the invention is defined by claims, and all changes which come within the meaning and range of equivalency of the claims are therefore intended to be embraced therein.

In the embodiment described above, the engine 140 includes an electronic throttle valve, and is used as the power source. However, the invention may be applied to a configuration where the motor without an electronic throttle valve is used as the power source.

1-6. (canceled)

7. A driving force control device, comprising:
a first target driving force calculation device that calculates a first target driving force based on an operation amount of an accelerator pedal by a driver;
a second target driving force calculation device that calculates a second target driving force that is necessary for a vehicle to maintain a constant vehicle speed or maintain a predetermined relative distance or relative speed relationship with a target object near the vehicle;
a driver's intention determining device that determines whether a driver intends to increase or reduce the vehicle speed;
a coordination device that coordinates the first target driving force and the second target driving force with each other, using a unit of driving force, in consideration of the intention of the driver which is determined by the driver's intention determining device; and
a driving force control device that controls a driving force generation device based on a target driving force derived through a coordination process performed by the coordination device, wherein
when the driver's intention determining device determines that the driver intends to increase the vehicle speed, the coordination device selects a greater value from among the first target driving force and the second target driving force; and
when the driver's intention determining device determines that the driver intends to reduce the vehicle speed, the coordination device selects a lesser value from among the first target driving force and the second target driving force.

8. A driving force control method, comprising:
calculating a first target driving force based on an operation amount of an accelerator pedal by a driver;
calculating a second target driving force that is necessary for a vehicle to maintain a constant vehicle speed or maintain a predetermined relative distance or relative speed relationship with a target object near the vehicle;
determining whether a driver intends to increase or reduce the vehicle speed;
coordinating the first target driving force and the second target driving force with each other, using a unit of driving force, in consideration of the determined intention of the driver; and
controlling driving force based on a target driving force derived through a coordination process, wherein
when it is determined that the driver intends to reduce the vehicle's speed, a lesser value is selected from among the first target driving force and the second target driving force; and
when it is determined that the driver intends to reduce the vehicle speed, a lesser value is selected from among the first target driving force and the second target driving force.
